(19) United States
(12) Patent Application Publication
(10) Pub. No.: US 2015/0183369 A1
(43) Pub. Date: Jul. 2, 2015

(54) METHOD, APPARATUS, COMPUTER PROGRAM AND SYSTEM FOR CONTROLLING A VEHICLE'S ALERT OUTPUT

(71) Applicant: Nokia Corporation, Espoo (FI)

(72) Inventor: Yan FU, Espoo (FI)

(21) Appl. No.: 14/579,058

(22) Filed: Dec. 22, 2014

(30) Foreign Application Priority Data
Dec. 30, 2013 (GB) 1323091.7

(51) Int. Cl. B60Q 5/00

(52) U.S. Cl. CPC B60Q 5/00

(57) ABSTRACT

Examples of the present disclosure relate to a method, apparatus, computer program and system for controlling a vehicle's alert output (such as a car's horn) comprising: receiving at least a first input related to at least one context of a vehicle; receiving at least a second input related to at least one context of the vehicle's driver; and controlling an output of an alert in dependence upon both: the at least one first input, and the at least one second input.

### TECHNOLOGICAL FIELD

Examples of the present disclosure relate to a method, apparatus, computer program and system for controlling a vehicle's alert output. In particular, though without prejudice to the foregoing, certain examples relate to controlling a vehicle's horn.

### BACKGROUND

A vehicle's horn is meant to be used in an emergency situation or to alert others as to the vehicles' presence. However, some drivers use the horn unnecessarily and in improper circumstances. Such abusive use of the horn creates unwarranted noise pollution. Certain examples of the present disclosure seek to mitigate inappropriate vehicle horn use and/or reduce noise pollution.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The present invention is as set out in the independent claims

According to at least some examples of the disclosure there is provided a method comprising causing, at least in part, actions that result in:
receiving at least a first input related to at least one context of a vehicle;
receiving at least a second input related to at least one context of the vehicle's driver; and
controlling an output of an alert in dependence upon both:
   the at least one first input, and
   the at least one second input.

According to at least some examples of the disclosure, there is provided a method comprising causing, at least in part, actions that result in: controlling an output of an alert of a vehicle in dependence upon a determination that the vehicle is in traffic congestion. The output of the alert of the vehicle may also be controlled based on a determination of a mood of a driver of the vehicle.

According to at least some examples of the disclosure, there is provided a method comprising causing, at least in part, actions that result in: determining a mood of a driver of a vehicle based on the driver's interaction with a driving control device of the vehicle. An output of an alert of the vehicle may be controlled in dependence upon the determination of the driver's mood.

According to at least some examples of the disclosure, there is provided a method comprising causing, at least in part, actions that result in: determining a mood of a driver of a vehicle based on a schedule of the driver. An output of an alert of the vehicle may be controlled in dependence upon the determination of the driver's mood.

According to at least some examples of the disclosure there is provided an apparatus comprising means configured to cause one or more of the above methods to be performed.

According to at least some examples of the disclosure there is provided a system comprising: the above apparatus, at least one sensor and at least one audio output device for outputting an alert.

According to at least some examples of the disclosure there is provided a vehicle comprising the above apparatus or system.

According to at least some examples of the disclosure there is provided a computer program that, when performed by at least one processor, causes one or more of the above methods to be performed.

### BRIEF DESCRIPTION OF THE DRAWINGS

For a better understanding of various examples that are useful for understanding the detailed description, reference will now be made by way of example only to the accompanying drawings in which:

FIG. 1 schematically illustrates a method according to an aspect of the present disclosure;

FIG. 2 schematically illustrates a further method according to an aspect of the present disclosure;

FIG. 3 schematically illustrates an apparatus according to an aspect of the present disclosure; and

FIG. 4 schematically illustrates a vehicle comprising an apparatus according to an aspect of the present disclosure.

### DETAILED DESCRIPTION

Examples of a method, apparatus and system according to the present disclosure will now be described with reference to the Figures.

According to an example of the present disclosure, there is provided a method 100 comprises causing, at least in part, actions that result in:
receiving 101 at least a first input 312 related to at least one context of a vehicle 401;
receiving 102 at least a second input 313 related to at least one context of the vehicle's driver 402; and
controlling 103 an output of an alert 403 in dependence upon both:
   the at least one first input, and
   the at least one second input.

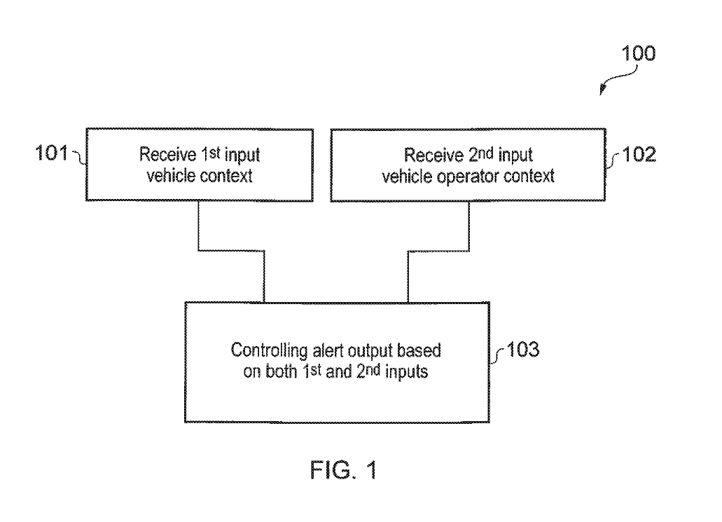

FIG. 1 illustrates a flowchart of a method 100 according to an example of the present disclosure

In block 101 a first input related to a context of a vehicle is received. The vehicle may comprise, not least for example, a car, a lorry, a motorbike. In block 102 a second input related to a context of the vehicle's driver is received. In certain examples blocks 101 and 102 of the flowchart 100 may be performed in a different order or overlapping in time, in series or in parallel.

In block 103 an output of an alert of the vehicle (e.g. an acoustic alert, such as an output from an acoustic transducer e.g. horn or speaker) is controlled in dependence upon both the first and second inputs. For example, a determination could be made as to whether or not both the first input meets a first criterion, and the second input meets a second criterion. The criterion may relate to the respective measured context: having a particular value, being above or below a threshold value, or having a particular profile.

Examples of the present disclosure may be in the form of a method and a corresponding apparatus consisting of various modules or means that provide the functionality for performing the steps of the method. The modules or means may be implemented as hardware, or may be implemented as software or firmware to be performed by a computer processor. In particular, in the case of firmware or software, examples of the present disclosure can be provided as a computer program product including computer readable instructions (i.e. the software or firmware) thereon for performing by the computer processor.

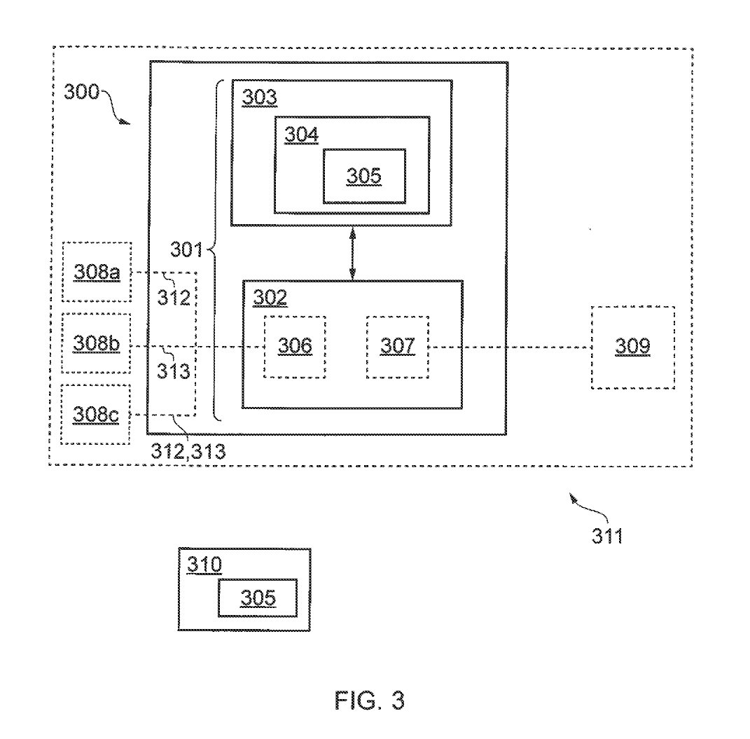

As will be discussed in greater detail below, and with respect to FIG. 3, the first 312 and second 313 inputs could be received at an apparatus 300, which then controls an alert output device 309 in dependence upon both of the vehicle context input and the driver context input. For example, where the two inputs are determined to meet one or more pre-determined criteria, the alert could be output in one particular manner, whereas where the criteria are not met, the alert could be output in a second particular manner.

Examples of the present disclosure enable a control of the output of the alert based on both on the vehicle's context as well as the driver's context. The vehicle's context, e.g. a detection that it is stationary, may be indicative of the vehicle being in traffic congestion/stuck in a traffic jam whilst the driver's context, e.g. a detection of the driver shouting or gesticulating, may be indicative of the driver being under some level of stress, is vexed or suffering from road rage. In such circumstances, there is a likelihood that any use of the alert would likely be an improper use of the alert, i.e. to vent the driver's frustration rather than emergency use. Advantageously, certain particular examples of the method, apparatus and system of the present disclosure enable an adjustment the directionality and/or volume of the alert in such a situation so as mitigate inappropriate use of the alert and reduce noise pollution.

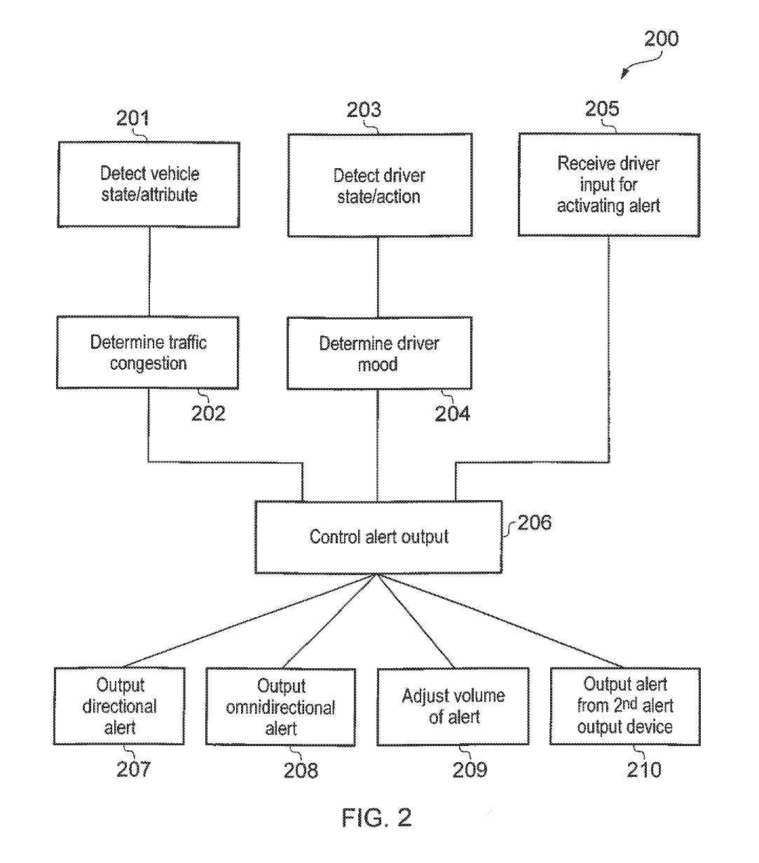

FIG. 2 schematically illustrates a flow chart of another method 200 according to a further example of the present disclosure.

The vehicle context to which the first input of block 101 relates may comprise: a condition, an attribute or a state of the vehicle. For example, the vehicle context may relate to at least one or more of the following vehicle conditions/attributes:
movement of the vehicle, speed of the vehicle, acceleration of the vehicle, use of an accelerator of the vehicle, deceleration of the vehicle, use of a brake of the vehicle, proximity of one or more objects (such as other vehicles) to the vehicle, other vehicles in the vicinity of the vehicle (e.g. their proximity and/or movement), and traffic information.

In block 201, one or more states, attributes and/or conditions of the vehicle are detected, sensed or measured by one or more vehicle sensors/detectors. The outputs from the one or more vehicle sensors are provided as the first input to the apparatus 300.

The vehicle conditions/attributes may relate to currently detected conditions as well as previously detected conditions, e.g. conditions detected in the past such as within a predetermined period of time from the present so as to provide a record/log of recent conditions.

The vehicle conditions/attributes may be derived from one or more sensors or detectors 308a, located in the vehicle itself, which are configured to detect, sense and/or measure the various vehicle conditions/attributes.

The first input may comprise a message or signal from a separate device, such as a driver's portable electronic communications device, a remote server or even a traffic monitoring station which could provide information such as traffic levels in the vicinity.

The detected vehicle conditions/attributes for the first input may be used to determine the context of the vehicle. In particular, the vehicle conditions/attributes used may comprise those whose values are indicative of a state of traffic congestion.

In block 202, based on the detected vehicle conditions/attributes a determination is made to as a state of traffic congestion, i.e. whether or not the vehicle is in a traffic jam. The determination may, for example, comprise referring to a lookup table which defines a congestion level based on measurement values of the one or more vehicle sensors and determining whether the congestion level meets a predetermined criterion/threshold level. The determination may comprise determining whether a detected vehicle condition/attribute meets a predetermined criterion. Two or more vehicle conditions/attributes may be combined (and differently weighted) in the determination. The measured vehicle attributes/conditions and their associated criteria could be selected such that the respective measurement values meeting the respective criteria is indicative of the vehicle being in traffic congestion. For example, based on a determination that the vehicle is stationary and that there is another vehicle just in front, it could be inferred that the car is stuck in a traffic jam. Measurement of the vehicle's recent acceleration/deceleration as well as accelerator and brake use can be used to determine repeated stopping and starting of the vehicle which is further indicative of the vehicle being in traffic congestion. Vehicle sensors could be provided that are configured to detect movement of external objects, such as other vehicles. This enables a determination to be made as to whether or not neighbouring/adjacent vehicles are moving and/or moving relative to the vehicle itself. The vehicle context may relate to the speed of neighbouring/adjacent vehicles and a determination as to whether or not neighbouring/adjacent vehicles are moving faster or slower than the vehicle itself.

The driver context to which the second input of block 102 relates may comprise: a state, an attribute, an action or a condition of the vehicle's driver. For example, the driver context may relate to at least one or more of the following driver actions/attributes:

movement of the driver, an activity of the driver, an action of the driver, a gesticulation of the driver, a vocal expression/utterance of the driver, a facial expression of the driver, a gaze of the driver and a schedule of the driver.

In block 203, one or more actions/attributes of the driver are detected, sensed or measured by one or more driver sensors/detectors. The outputs from the one or more driver sensors are provided as the second input to the apparatus 300.

The driver actions/attributes may relate to currently detected actions as well as previously detected actions, e.g. actions detected in the past such as within a predetermined period of time from the present so as to provide a record/log of recent actions. For example, where the car vehicle has recently undergone a series of repeated acceleration and braking, this might be considered indicative of stop start movement typical of traffic flow in traffic congestion.

The driver actions/attributes may be derived from one or more sensors or detectors 308b, located in the vehicle itself, which are configured to detect, sense and/or measure the various driver actions/attributes. For example, the driver sensors may be configured to detect and quantify driver actions such as:
visually detected characteristics of the driver, e.g. movement or facial expression of the driver
acoustically detected characteristics of the driver, e.g. speech, sounds, utterances or cursing performed by the driver
haptic characteristics of the driver, e.g. a touch, squeeze or impact made by the driver.

The driver sensors include, but are not limited to: pressure sensors, image capture devices, audio capture devices. For example, a vehicle control device of the vehicle, such as a steering wheel of the vehicle, may be provided with one or more force detectors that could detect a user squeezing, shaking, and hitting the steering wheel when a particular profile of force or excessive amount of force is detected. Such actions could be considered as being atypical use of the vehicle control device (and indicative of a driver having elevated stress levels), as compared to normal use, for example, normal use of a steering wheel would typically involve the driver rotating the steering wheel. Atypical use/handling of the vehicle control device could be determined based on a detection of a driver's interaction/touch of the vehicle control device in combination with one or more other sensor measurements, for example a detection that the vehicle is stationary/undergoing limited movement or a detection of an absence of rotation of a steering wheel.

The detected driver actions/attributes for the second input may be used to determine a context of the driver. In particular, the actions/attributes may comprise those whose values are indicative of a mood, behaviour or stress level of the driver

In block 204, based on the detected driver actions/attributes, a determination is made as to a mood of the driver, i.e. whether or not the driver is stressed, frustrated, vexed. The determination may, for example, comprise referring to a lookup table which defines a mood state/stress level of the driver based on measurement values of the one or more driver sensors determining whether the mood state/stress level meets a predetermined criterion/threshold level. The determination may comprise determining whether a detected driver action/attribute meets a predetermined criterion. Two or more driver actions/attributes may be combined (and differently weighted) in the determination. The measured driver actions/attributes and their associated criteria could be selected such that the respective measurement values meeting the respective criteria is indicative of the driver being stressed, frustrated or having some degree of road rage. For example, based on observable behaviour of the driver, such as movements and vocal expressions, a determination that the driver is hitting a steering wheel and cursing, it could be inferred that the driver is frustrated and suffering from some degree of ‘road rage’.

In block 205, a driver input for activating an alert is received. For example, this may correspond to the driver actuating a horn of the vehicle. It is noted that this particular driver input is separate from and distinct to the driver actions detected in block 203.

Responsive to the driver input of block 205, an alert is caused to be output. The control of the alert output in block 206 may correspond to outputting one type of alert where the criterion is met and outputting another type of alert where the criterion is not met, such as outputting a normal alert when the criteria are not met and outputting an adjusted alert when the criteria are met. For example, the output of the alert may be controlled in dependence upon both the determined state of traffic congestion and the determined mood of the driver, such that where it is determined that the vehicle is stuck in traffic and the driver is stressed, when the driver honks the horn, the volume of the horn is reduced as compared to the normal volume of the horn.

Blocks 207-210 show a selection of some of the various ways in which the alert output may be controlled so as to mitigate abusive use of the vehicle's alert and/or reduce noise pollution.

In block 207, a directional alert is outputted, i.e. an alert whose power output is adjusted such that it is predominately directed/focused/concentrated in a particular direction so that the alert has more power and is louder in some particular directions, e.g. a forward direction of the vehicle, than others directions. Where a driver activates his vehicle's alert in situations where he is stuck in traffic and frustrated, typically the alert is intended for third parties/other drivers in front of the driver. The driver may be venting his frustration due to, not least, the driver(s) in front: not moving/moving too slowly, driving slower than drivers in neighbouring lanes, changing lanes and giving way to other drivers. Accordingly, it is advantageous to enable the alert to be primarily directed/focused frontwards at such third parties/other drivers in front of the driver.

In block 208, an omnidirectional alert is outputted, i.e. an alert whose power output is substantially equal on all directions. It is to be appreciated that an omnidirectional alert is just one possible example of a normal/default alert of the vehicle that can be output at block 208 when the criteria are not met, whereas in block 207 a different alert, i.e. different from the normal/default alert, is output where the criteria are met. In block 209, a volume/amplitude of the alert is adjusted, for example it may be reduced in certain particular directions or reduced in all directions. In block 210 the alert is additionally outputted from a second alert output device.

The control of the output of the alert may comprise combinations of blocks 207-210.

Other devices may also be controlled in response to the determination of one or more of the determined traffic congestion and driver's mood. In one example a navigational device is controlled, e.g. so as to redirect the vehicle's navigation route to an alternative route, such as a safer route whereby the driver may be able to calm down by avoiding traffic congestion. In another example a proximity alert device (e.g. radar distance sensors or proximity/parking sensor) is controlled, e.g. so as to increase the separation distance which triggers a warning alarm as compared to a normal/default separation distance.

In one particular example, a combination of blocks 209 and 210 is performed, i.e. a volume of an alert output from a first (primary) alert output device configured to alert third parties external of the vehicle (e.g. main car horn) could be reduced but a further alert is output from the second alert output device configured to alert the driver internal of the vehicle. Where the second alert output device is directed towards the driver (e.g. by virtue of it being located inside the vehicle, proximal to and aimed at the driver) even though the main alert volume is reduced, the driver could be kept oblivious to this due to the output of the alert from the second alert output device.

This particular example allows the driver vent his frustration in his usual fashion, namely honking the horn, and hearing a reassuringly loud alert inside the vehicle due to the second alert output device. However, the external loudness of the main alert would be reduced, at least in certain directions, thereby reducing noise pollution. Advantageously, the driver is able to vent his frustration in his usual manner, with minimal disturbance to third parties, which reduces the risk of the driver's frustration building up such that the driver might do something else more drastic which could have more severe ramifications.

The flowchart of FIG. 2 represents one possible scenario among others. The order of the blocks shown is not absolutely required, so in principle, the various blocks can be performed out of order. For example, one or more of blocks 201-204 could be performed before, simultaneously or after (e.g. responsive to) the performance of block 205.

It is possible for some blocks of FIG. 2 to be omitted. For example, according to another method of the present disclosure, the method may comprise just blocks 202 and 206. The method may comprises causing, at least in part, actions that result in: controlling an output of an alert of a vehicle in dependence upon a determination that the vehicle is in traffic congestion. In this method, the output of the alert of the vehicle might also optionally be controlled based on a determination of a mood of a driver of the vehicle, as per block 204. It will be appreciated that the method may additionally comprise additional blocks.

According to another method of the present disclosure, the method may comprise just block 204. For example, the method may comprise causing, at least in part, actions that result in: determining a mood of a driver of a vehicle based on the driver's interaction with a driving control device of the vehicle. Alternatively, for example, the method may comprise causing, at least in part, actions that result in: determining a mood of a driver of a vehicle based on a schedule of the driver. In these methods, an output of an alert of the vehicle may be controlled in dependence upon the determination of the driver's mood, as per block 206. It will be appreciated that the method may additionally comprise additional blocks.

Examples of the present disclosure have been described above using flowchart illustrations. The blocks illustrated in FIGS. 1 and 2 may represent steps in a method and/or sections of instructions in a computer program. It will be appreciated that examples of the present disclosure may take the form of a method, an apparatus or a computer program.

The component blocks of FIG. 2 are functional and the functions described may or may not be performed by a single physical entity (such as apparatus 300 of FIG. 3) of a system of devices (such as system 311 of FIG. 3).

The blocks support: combinations of means and hardware configured to perform the specified functions; combinations of steps for performing the specified functions; and computer program instructions/algorithms that can direct a programmable apparatus to function in a particular manner to perform the specified functions. It will also be understood that each block, and combinations of blocks, can be implemented by special purpose hardware-based systems which perform the specified functions or steps, or combinations of special purpose hardware and computer program instructions.

FIG. 3 schematically illustrates an example of an apparatus 300 for performing the above described methods. FIG. 3 focuses on the functional elements necessary for describing the operation of the apparatus.

The apparatus 300 comprises a controller 301 which can be implemented in hardware alone (e.g. processing circuitry comprising one or more processors 302 and memory circuitry comprising one or more memory elements 303), have certain aspects in software including firmware alone or can be a combination of hardware and software (including firmware).

The controller may be implemented using instructions 305 that enable hardware functionality, for example, by using executable computer program instructions 305 in a general-purpose or special-purpose processor 302 that may be stored on a computer readable storage medium 310 (disk, memory etc.) or carried by a signal carrier to be performed by such a processor.

In the illustrated example, the apparatus 300 comprises a controller 301 which is provided by a processor 302 and memory 303. Although a single processor and a single memory are illustrated in other implementations there may be multiple processors and/or there may be multiple memories some or all of which may be integrated/removable and/or may provide permanent/semi-permanent/dynamic/cached storage.

The memory 303 stores a computer program 304 comprising computer program instructions 305. The instructions control the operation of the apparatus 300 when loaded into the processor 302. The processor 302 by reading the memory 303 is able to load and execute the computer program 304. The computer program instructions 305 provide the logic and routines that enables the apparatus 300 to perform the methods described above and illustrated in FIGS. 1 and 2.

The processor 302 is configured to read from and write to the memory 303. The processor 302 may also comprise an input interface 306 via which data, commands and/or signals are input to the processor 302. In particular one or more first inputs 312 may be received by from one or more vehicle sensors 308a, and one or more second inputs 313 may be received from one or more driver sensors 308b. Also, further inputs to the processor could be received from a receiving device 308c, such as an antenna.

The processor 302 may also comprise an output interface 307 via which data and/or commands are output by the processor 302. In particular, commands/control signals could be output to one or more output alert devices 309 to control the output of an alert.

The computer program may arrive at the apparatus 100 via any suitable delivery mechanism. The delivery mechanism may be, for example, a non-transitory computer-readable storage medium 310, a computer program product, a memory device, a record medium such as a compact disc read-only memory or digital versatile disc, an article of manufacture that tangibly embodies the computer program. The delivery mechanism may be a signal configured to reliably transfer the computer program 304.

The apparatus 300 may be embodied as a chipset or a module. As used here ‘module’ refers to a unit or apparatus that excludes certain parts/components that would be added by an end manufacturer or a user.

The apparatus may comprise a part of a device or system 311 which further comprises one or more: vehicle sensors 308a, driver sensors 308b and receivers 308c for receiving signals, data or information from other devices.

Sensor signals from the vehicle sensors 308a and driver sensors 308b provide the first input 312 and second input 313 respectively. Sensor signals could be received at the apparatus 300 via any suitable communication means, including wires and wireless.

A first input may also be received via a receiving device 308c such as an antenna, to receive information, data and/or signals from a device remote of the vehicle, such as: a remote server, other vehicles or remote monitoring devices. The first input may, for example, relate to traffic information. Likewise, a second input may also be received via a receiving device 308c such as an antenna, to receive information, data and/or signals from a separate device, such as a remote server or a portable electronic device (e.g. mobile phone) belonging to the driver. The second input may relate to a planned schedule/diary event, for example, which may indicate a meeting starting at a particular time at a particular location, from which information it is possible to ascertain that the driver is running late.

Although examples of the apparatus have been described above as comprising various components, it should be understood that the components may be embodied as or otherwise controlled by a corresponding processing element or processor of the apparatus. For example, the sensors 308a and 308b may be smart sensors comprising their own processor, memory and communication interface. Each of the components described above may be one of more of any device, means or circuitry embodied in hardware, software or a combination of hardware and software that is configured to perform the corresponding functions as discussed above of the respective components.

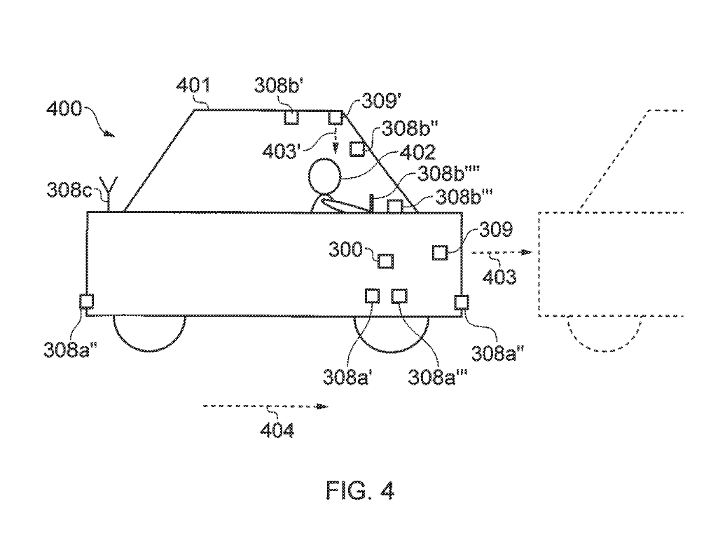

FIG. 4 schematically illustrates an example of a system 400 of the present disclosure. The apparatus 300 is embodied in a vehicle 400 driven by a driver 402. The apparatus receives signals, measurements and information from the various sensors 308a, 308b and devices 308c.

The vehicle sensors 308a for obtaining vehicle context information may include:
at least one sensor 308a′ for detecting motion or speed of the vehicle;
at least one sensor 308a″ for detecting another vehicle (shown in outline) proximal to the front and/or rear of the vehicle (e.g. less than 10, 1 and 0.1 metres of the vehicle). This could comprise a proximity detector, e.g. sonar based, and an image capture device with image recognition to identify images of vehicles;
at least one sensor 308a′″ for detecting use of an accelerator and/or a brake of the vehicle;
a receiver 308c for receiving vehicle context information, such as traffic information from a separate device, remote server or monitoring device.

The driver sensors 308b for obtaining context information regarding the driver 402 may include:
at least one sensor 308b′ for detecting motion, gestures, gesticulations of the driver. These could comprise a motion detector and/or an image capture device with image recognition to determine and identify captured images of driver movement;
at least one sensor 308b″ for detecting the driver's facial expression. These could comprise an image capturing device with image recognition processing to determine and identify facial expressions;
at least one sensor 308b′″ for detecting sounds, speech and/or the driver's voice. These could comprise a sound capturing device with voice recognition to determine and identify the driver's voice as well particular words (e.g. curse words) and a loudness level of the same;
at least one sensor 308b″″ for detecting a driver: touching, gripping, shaking, and hitting an object;
a receiver 308c for receiving driver context information, such as schedule information/a diary entry from a separate device, e.g. a hand-held electronic device of the driver, or a remote server.

The system also comprises a first alert output device 309, such as a conventional horn or speaker, for outputting an alert 403. This may be configured to have at least two modes: a normal mode and an adjusted mode. The normal mode may be, for example, whereby the output of the alert is substantially omnidirectional in that the radiated power output of the alert is substantially equal in all directions, or at least in directions in front of, behind and to the side of the vehicle. The adjusted mode may be, for example, whereby the output of the alert is directed in a particular direction, e.g. in a forwards facing direction 404 of the vehicle, such that the power output is greater in one particular direction 404 than other directions. Alternatively, the adjusted mode may comprise attenuating the output in one or more directions, e.g. sideways or rearwards. Yet further, the adjusted mode may comprise a reduction of the volume of the alert as compared to the normal mode. The control of the output of the alert may comprise selecting the output mode by which the alert is to be output.

The controllable directionality of the first (main/primary) output device may be provided via any suitable means, not least by the first output device comprising two or more output devices orientated in different directions.

The system also comprises a second alert output device 309′, whose alert output 403′ is directed towards to driver, i.e. the second alert output device 309′ is configured to provide an alert internal of the vehicle to the driver, in contrast to the first alert output device 309 which is configured to provide an alert external of the vehicle to third parties. The second alert output device 309′ may be located proximal to the driver inside the vehicle.

As used in this application, the term ‘circuitry’ refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.”

Features described in the preceding description may be used in combinations other than the combinations explicitly described.

Although functions have been described with reference to certain features, those functions may be performable by other features whether described or not. Although features have been described with reference to certain examples, those features may also be present in other examples whether described or not. Although various examples of the present disclosure have been described in the preceding paragraphs, it should be appreciated that modifications to the examples given can be made without departing from the scope of the invention as claimed.

The term ‘comprise’ is used in this document with an inclusive not an exclusive meaning. That is any reference to X comprising Y indicates that X may comprise only one X or may comprise more than one X. If it is intended to use ‘comprise’ with an exclusive meaning then it will be made clear in the context by referring to “comprising only one.” or by using “consisting”.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

In this brief description, reference has been made to various examples. The description of features or functions in relation to an example indicates that those features or functions are present in that example. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class.

Whilst endeavouring in the foregoing specification to draw attention to those features of the present disclosure believed to be of particular importance it should be understood that the Applicant claims protection in respect of any patentable feature or combination of features hereinbefore referred to and/or shown in the drawings whether or not particular emphasis has been placed thereon.

We claim:

1. A method comprising causing, at least in part, actions that result in:
receiving at least a first input related to at least one context of a vehicle;
receiving at least a second input related to at least one context of a driver of the vehicle; and
controlling an output of an alert in dependence upon both:
the at least one first input, and
the at least one second input.

2. The method of claim 1, wherein the at least one vehicle context relates to one or more of:
movement of the vehicle, speed of the vehicle, acceleration of the vehicle, deceleration of the vehicle, proximity of one or more objects to the vehicle, other vehicles in the vicinity, and traffic information.

3. The method of claim 1, wherein the at least one vehicle context is determined based on one or more measurements from one or more vehicle sensors.

4. The method of claim 1, further comprising determining a state of traffic congestion based on the at least first input.

5. The method of claim 1, wherein the at least one driver context relates to one or more of:
movement of the driver, an activity of the driver, an action of the driver, a gesticulation of the driver, a vocal expression of the driver, a facial expression of the driver and a schedule of the driver.

6. The method of claim 1, wherein the at least one driver context is determined based on one or more measurements from one or more driver sensors.

7. The method of claim 1, further comprising determining a mood of the driver based on the at least second input.

8. The method of claim 1, wherein controlling the output of the alert comprises adjusting a directionality of the output of the alert.

9. The method of claim 1, wherein controlling the output of the alert comprises adjusting a directionality of the output of the alert such that the alert is output in a direction substantially frontwards of the vehicle.

10. The method of claim 1, wherein the output of the alert has at least a first alert output mode and a second alert output mode, further wherein controlling the output of the alert comprises selecting one of the alert output modes.

11. The method of claim 10, wherein the first output mode comprises a substantially omnidirectional alert output and the second output mode comprises a substantially directional alert output.

12. The method of claim 1, further comprising causing, at least in part, actions that result in controlling, in dependence upon the first input and/or the second input, one or more of: a navigation device and a proximity alert device.

13. An apparatus comprising:
at least one processor; and
at least one memory including computer program code for one or more programs, the at least one memory and the computer program code configured to, with the at least one processor, cause the apparatus to perform at least the following,
receive at least a first input related to at least one context of a vehicle;
receive at least a second input related to at least one context of a driver of the vehicle; and
control an output of an alert in dependence upon both:
the at least one first input, and
the at least one second input.

14. An apparatus of claim 13, wherein the at least one vehicle context relates to one or more of:
movement of the vehicle, speed of the vehicle, acceleration of the vehicle, deceleration of the vehicle, proximity of one or more objects to the vehicle, other vehicles in the vicinity, and traffic information.

15. An apparatus of claim 13, wherein the at least one vehicle context is determined based on one or more measurements from one or more vehicle sensors.

16. An apparatus of claim 13, wherein the apparatus is further caused to determine a state of traffic congestion based on the at least first input.

17. An apparatus of claim 13 wherein the at least one driver context relates to one or more of:
movement of the driver, an activity of the driver, an action of the driver, a gesticulation of the driver, a vocal expression of the driver, a facial expression of the driver and a schedule of the driver.

18. An apparatus of claim 13, wherein the at least one driver context is determined based on one or more measurements from one or more driver sensors.

19. An apparatus of claim 13, wherein the apparatus is further caused to determine a mood of the driver based on the at least second input.

20. An apparatus of claim 13, wherein controlling the output of the alert comprises adjusting a directionality of the output of the alert.

21. An apparatus of claim 13, wherein controlling the output of the alert comprises adjusting a directionality of the output of the alert such that the alert is output in a direction substantially frontwards of the vehicle.

22. An apparatus of claim 13, wherein the output of the alert has at least a first alert output mode and a second alert output mode, further wherein controlling the output of the alert comprises selecting one of the alert output modes.

23. An apparatus of claim 22, wherein the first output mode comprises a substantially omnidirectional alert output and the second output mode comprises a substantially directional alert output.

24. An apparatus of claim 13, wherein the apparatus is further caused to control, in dependence upon the first input and/or the second input, one or more of: a navigation device and a proximity alert device.
